(19) United States
(12) Patent Application Publication
(10) Pub. No.: US 2007/0120335 A1
(43) Pub. Date: May 31, 2007

(54) Skateboard ski with spring suspension

(76) Inventors: Brad Birdsell, Phoenix, AZ (US); Eric Raymond Hansen, Phoenix, AZ (US); David M. Shipley, Peoria, AZ (US)

Correspondence Address: Brad Birdsell, 3138 West Monte Cristo Ave, Phoenix, AZ, 85053, US

(21) Appl. No.: 11/291,162

(22) Filed: Nov. 30, 2005

(51) Int. Cl. B62B 13/00

(52) U.S. Cl. 280/14.21

(57) ABSTRACT

A skateboard/ski combination wherein the four wheels of a traditional skateboard have been removed, while the skateboard trucks remain in place, and are then replaced with four ski apparatuses. An anchoring plate connects springs from the underside of the skateboard deck to the ski apparatus base that maintains a traditional ski shape, with rails that protrude outward from the front and rear of the ski base, still maintaining a traditional ski shovel shape. The ski base, which has a flat or concave surface perpendicular to the length of the ski, contains a radius positioned longitudinally to the ski length (rocker) that then transitions to a small radius at the front and rear of the skis, thereby providing a traditional ski shovel in the front and rear of the ski base. Metal or plastic rails are mounted to the ski base on opposing sides of the base in a vertical fashion, extending below the surface of the base. The rails have a radius positioned longitudinally to the ski length (rocker) that transitions to a small radius at both the front and rear ends of the base. An alternative spring suspension system uses torsion springs located in the vicinity of the axle hole on the skateboard truck. This combination allows the user to perform traditional skateboard maneuvers on snow.

### PRIOR APPLICATION

Not Applicable.

### FIELD OF THE INVENTION

This invention relates to the field of skateboards and snow skis/snowboards, in particular, the instant invention involves a traditional skateboard that has been transformed into a skiing device that can perform skateboard maneuvers on snow.

### BACKGROUND OF THE INVENTION

In the area of skateboarding, skateboarders have traditionally had to turn to snowboards to have similar recreation in the snowy weather. Snowboarding, however, varies in many significant ways from skateboarding. The most obvious difference is the fact that a snowboarder's feet are bound and attached through boots to the snowboard, whereas, on a skateboard, the rider's feet are merely placed on top of the deck of the skateboard and are easily freed from the board to perform tricks and to discontinue the use of the board. Another significant difference is the feel and handling of the snowboard compared to a skateboard due to the fact that the skateboard has wheels and a truck between the deck and the ground that allows for steering and control while a snowboard's deck comes in direct contact with the ground. The locked-in feet and lack of suspension/steering ability make snowboarding a related, but different skill than skateboarding. Another feature of snowboarding and skiing is that both are edging devices. The instant invention, on the other hand, provides a turning/steering ability rather than an edging ability.

There have been devices known in the prior art that purport to combine skateboarding and snow recreation. However, none of the previous inventions have been able to offer the same suspension/steering or truck turning ability found on skateboards that are required to perform skateboard tricks. Chou in U.S. Pat. No. 6,481,725 teaches of a skateboard that attaches to one traditional ski. This invention does not have any spring suspension/steering ability, however. Differing from the instant invention, this device involves a single ski with no independent truck-turning ability. Similarly, Dotson in U.S. Pat. No. 4,116,455 involves a skateboard platform combined with removable ski shoes. No spring suspension/steering ability is included in this invention and therefore, most, if not all, skateboard tricks are not achievable on this device. This invention defines a board with only two skis, therefore there is no independent suspension and the define ski does not have the rocker provided in the instant invention.

Hirbod in U.S. Pat. No. 4,181,319 discloses a self-propelled skateboard with improved suspension capabilities. However, this invention is very complex, contains footpads and mechanisms for use with the hands. Therefore, a need exists for a simple skateboard/ski combination, without foot bindings, that can be used on snow and that has the same suspension/steering abilities that a skateboard does on pavement.

### SUMMARY OF THE INVENTION

In the preferred embodiment of the invention, a skateboard/ski combination is described. A traditional skateboard deck has its wheels removed. The skateboard trucks remain in place, however. The four wheels on the traditional skateboard truck are replaced with four skis. The apparatus contains a spring suspension/steering system providing a neutral location of the skis at rest that rebounds to a neutral location when the skis are excited by external force.

The spring suspension/steering system includes two anchoring plates that are mounted between the underside of the skateboard deck and the trucks. The anchoring plates are hooked to a plurality of extension springs either through holes or prongs. Each ski has two extension springs connected between the ski and the anchor plate. The anchor plate helps create a tool-less ability to pre-load the skis for desired ride and functionality. The skis can be pre-loaded in either direction by disconnecting one spring per ski, be it the inboard or outboard springs, to achieve the desired performance enhancements.

The skis are composed of a base made of either plastic or metal that has a traditional ski shape, i.e., providing a ski shovel at both the front and rear ends of said base. The ski base, which has a flat or concave surface perpendicular to the length of the ski, contains a radius positioned longitudinally to the ski length (rocker) that then transitions to a small radius at the front and rear of the skis. This provides a traditional ski shovel in the front and rear of the ski base. Metal or plastic rails are mounted to the ski base on opposing sides of the base in a vertical fashion, extending below the surface of the base. The rails have a radius positioned longitudinally to the ski length (rocker) that transitions to a small radius at both the front and rear ends of the base. These rails are interchangeable to achieve different types of performance characteristics and to quickly and easily repair or replace worn or damaged rails.

In an alternative embodiment of the invention, the spring suspension/steering system is comprised of a torsion spring mounted inside of the vertical portion of the skateboard/ski combination in the vicinity of the hole of the axle. The torsion springs act against the axle and the ski base to provide a neutral suspended location and spring tension when he ski is rotated about the axle in either a clockwise or counterclockwise direction.

Another alternative embodiment of the invention involves the addition of a multi-purpose leash and cuff assembly that attaches the board to the rider that is added for safety and utility.

### OBJECT OF THE INVENTION

The principal object of the invention is to replace the wheels on a traditional skateboard with skis. This allows the skateboard rider to ride on snow with the same agility as the traditional wheeled skateboard on pavement. The rider will be able to perform all the same tricks and maneuvers as on a non-snowy surface. Skateboarders, snowboarders and anyone interesting in trying new sports will find this invention useful.

### DESCRIPTION OF THE DRAWINGS

FIG. 1 illustrates a top view of the invention.

FIG. 2 illustrates a side view of the invention.

FIG. 3 illustrates a perspective view of the invention.

FIG. 4 illustrates an end view of the invention.

### DETAILED DESCRIPTION OF AN ENABLING AND PREFERRED EMBODIMENT

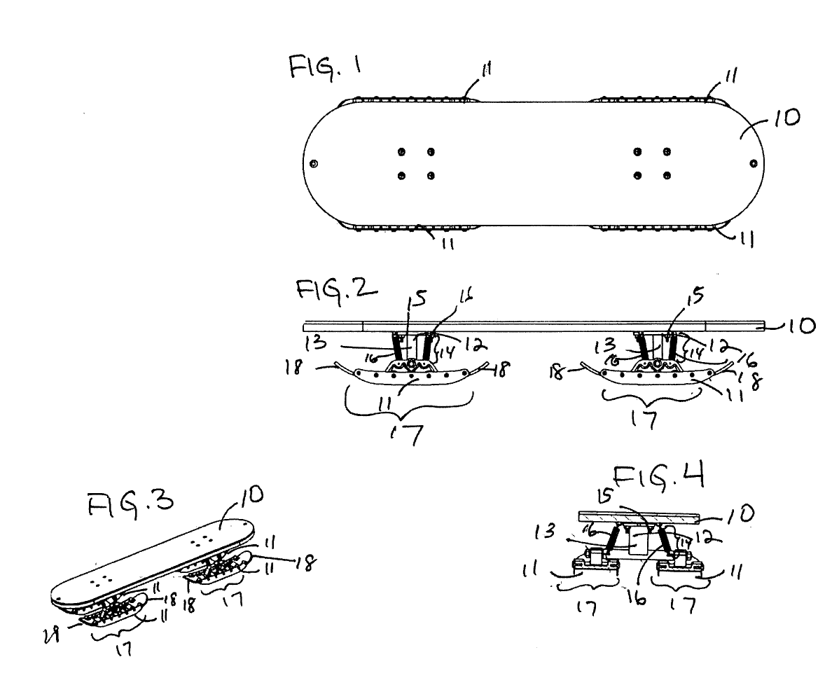

For a better understanding of the invention, we turn now to the drawings. FIG. 1 offers a top view of the skateboard deck 10 with the skis 11 somewhat obscured underneath. The skis 11 are more readily seen in FIGS. 2-4. The skateboard deck 10 has its wheels removed, while the trucks 12 remain in place. The invention includes a spring suspension/steering system 14 providing a neutral location of the skis at rest that rebounds to a neutral location when the skis are excited by external force.

The spring suspension/steering system 14 includes two anchoring plates 15 that are mounted between the underside of the skateboard deck 10 and the trucks 12. The anchoring plates 15 are hooked to a plurality of extension springs 16 either through holes or prongs (not shown). Each ski 11 has two extension springs 16 connected between the ski 11 and the anchoring plate 15.

The skis 11 are composed of a base 17 made of either plastic or metal that has a traditional ski shape, i.e., providing a ski shovel at both the front and rear ends of the base 17. The ski base 17, which has a flat or concave surface perpendicular to the length of the ski 11, contains a radius positioned longitudinally to the ski length (rocker) that then transitions to a small radius at the front and rear of the skis 11. This provides a traditional ski shovel in the front and rear of the ski base 17. Metal or plastic rails 18 are mounted to the ski base 17 on opposing sides of the base in a vertical fashion, extending below the surface of the base 17. The rails 18 have a radius positioned longitudinally to the ski length (rocker) that transitions to a small radius at both the front and rear ends of the base 17. These rails are interchangeable to achieve different types of performance characteristics and to quickly and easily repair or replace worn or damaged rails.

In an alternative embodiment of the invention, the spring suspension/steering system is comprised of a torsion spring (not shown) mounted inside of the vertical portion 13 of the skateboard/ski combination in the vicinity of the hole of the axle 13. The torsion springs act against the axle 13 and the ski base 17 to provide a neutral suspended location of the skis and spring tension when the ski 11 is rotated about the axle 13 in either a clockwise or counterclockwise direction.

The illustrations and examples, provided herein explanatory purposes and are not intended to limit the scope of the appended claims, as those skilled in the art will make modifications to the invention for particular uses.

I claim:

1. A skateboard/ski combination comprising
a traditional skateboard deck with the wheels removed, but with the trucks remaining in place;
a spring suspension system that provides a neutral location of the skis at rest and that rebounds to a neutral location when the skis are excited by external force, said spring suspension system further comprising
two anchoring plates that are mounted between the underside of said deck and said trucks, said anchoring plates further comprising a means on which to hook extension springs;
a plurality of extension springs connected from said anchoring plates to one of each of said skis, said skis further comprising
a base with a traditional ski shape that provides a ski shovel at both the front and rear ends of said base, said base having a surface perpendicular to the length of said ski, said ski containing a radius positioned longitudinally to the ski length (rocker) that then transitions to a small radius at the front and rear of said skis, thereby providing a traditional ski shovel in the front and rear of said ski base; means for connecting said base to said extension springs;
rails mounted longitudinally to said base on opposing sides of said base in a vertical fashion, extending below the surface of said base, said rails containing a radius positioned longitudinally to said ski length (rocker) that transitions to a small radius at both the front and rear ends of said base.

2. A skateboard/ski combination according to claim 1 wherein said means on which to hook said extension springs are holes.

3. A skateboard/ski combination according to claim 1 wherein said means on which to hook said extension springs are prongs.

4. A skateboard/ski combination according to claim 1 wherein said rails are made of metal.

5. A skateboard/ski combination according to claim 1 wherein said rails are made of plastic.

6. A skateboard/ski combination according to claim 1 wherein said spring suspension system comprises a torsion spring mounted inside of the vertical portion of said skateboard/ski combination in the vicinity of the hole of said axle, said torsion springs acting against said axle and said ski base to provide a neutral suspended location and spring tension when said ski is rotated about said axle in either a clockwise or counterclockwise direction.

7. A skateboard/ski combination according to claim 1 wherein said base surface is flat.

8. A skateboard/ski combination according to claim 1 wherein said base surface is concave Perpendicular to ski length.

9. A skateboard/ski combination according to claim 1 wherein said rails are interchangeable in order to achieve different types of performance characteristics and to quickly and easily repair or replace worn or damaged rails

10. A skateboard/ski combination according to claim 1 wherein a leash and cuff assembly is added that attaches the board to the rider.

11. A skateboard/ski combination according to claim 1 wherein said ski is constructed of plastic.

12. A skateboard/ski combination according to claim 1 wherein said ski is constructed of metal.

13. A skateboard/ski combination according to claim 1 wherein said ski is constructed of a composite of plastic and/or metal and/or wood.
